(19) United States
(12) Patent Application Publication
(10) Pub. No.: US 2015/0025926 A1
(43) Pub. Date: Jan. 22, 2015

(54) SYSTEMS AND METHODS FOR ENHANCED USE OF DATA IN AGRICULTURE MANAGEMENT

(71) Applicant: O & B Marketing, LLC, St. Louis, MO (US)

(72) Inventors: Mark L. Green, St. Louis, MO (US); Chris Carl, St. Louis, MO (US); Michael L. Turley, Town & Country, MO (US); Christopher Lee Feix, Columbia, IL (US)

(21) Appl. No.: 14/334,451

(22) Filed: Jul. 17, 2014

Related U.S. Application Data
(60) Provisional application No. 61/847,499, filed on Jul. 17, 2013.

(51) Int. Cl. G06Q 10/06; G06Q 50/02; G06Q 30/02

(52) U.S. Cl. CPC G06Q 10/06311; G06Q 30/0201; G06Q 50/02
USPC 705/7.13

(57) ABSTRACT

A computer system for managing agricultural sales involving a salesperson and a first grower is provided. The computer system includes a database. The computer system also includes a processor. The processor is programmed to store historical sales data for the first grower in the database. The historical sales data includes a prior purchase of a first agricultural product by the grower. The processor is also programmed to identify a second agricultural product appropriate for the first grower based at least in part on the historical sales data. The processor is further programmed to create a task for the salesperson. The task is related to engaging the first grower regarding the second agricultural product. The processor is also programmed to display the task to the salesperson for engaging the first grower.

### CROSS REFERENCE TO RELATED APPLICATIONS

This application claims priority to U.S. Provisional Application No. 61/847,499, filed Jul. 17, 2013, which is hereby incorporated by reference in its entirety.

### BACKGROUND OF THE DISCLOSURE

The field of the disclosure relates generally to agricultural data systems and, more specifically, to systems and methods for enhancing the use of agricultural data in agricultural sales, distribution, and manufacturing that includes centralizing and leveraging agricultural data by multiple partners in the agricultural market from the manufacturer to the grower/consumer.

In recent years, the agricultural industry has experienced many technological strides and advances that have improved productivity. Advancements in nutrient management of field soil allows growers to better understand how the soil changes from season to season, and better understand what crops need to thrive. For example, advancements in fertilizers, such as the ability to synthesize ammonium nitrate, gives growers a significant tool to assist crop growth. Continuing development of pesticides and herbicides allow growers to protect fields and crops from insect and weed dangers. Advancements in seed genetics, such as natural breeding practices, hybridization, and more recent genetic engineering discoveries, gives growers specialized crops that can thrive in different environments based on local factors. Advancements in farming mechanization, such as precision farming equipment and techniques, gives growers access to tools such as variable rate seed and fertilizer application, harvesting quantity and rate information, any of which may leverage GPS positioning data to track, record, and correlate data about the fields. Satellite and other aerial imagery give growers tools to both collect data and map their fields. Site-specific crop and field management methods help growers manage fields and make specific planting and management decisions based on more detailed information related to their individual fields.

All of these advanced agricultural management tools add to the productivity of farm fields, but they are becoming, or already are, data driven and computerized tools. Some known precision farming equipment collects data about what seed was planted, at what particular rate at a given position within the field, and can provide a field map showing this and other data views. Some known application equipment can apply fertilizers at variable, and configurable, rates at particular locations within the field. And some known harvesting equipment collects production data from the same fields, including production rate mapping to particular positions within the field. All of this data is available for correlation and analysis during various phases of the agricultural management lifecycle.

Precision farming generates a significant amount of data relative to individual growers, giving growers quantifiable, after-the-fact data that may be used to increase understanding of, for example, how a given seed performed in a particular field, or how productive a given field was after application of a particular fertilizer. Such grower data presents many use possibilities that have not yet been fully leveraged. What is needed is a comprehensive system of collecting and centralizing grower data in a way that may be used not only by individual growers after the fact, but by growers prior to decision-making, and by other partners in the supply chain, such as manufacturers of seed and fertilizer, distributors, and sales forces, all of which serve the grower in aspects of agriculture management.

### BRIEF DESCRIPTION OF THE DISCLOSURE

In one aspect, a computer system for managing agricultural sales involving a salesperson and a first grower is provided. The computer system includes a database. The computer system also includes a processor. The processor is programmed to store historical sales data for the first grower in the database. The historical sales data includes a prior purchase of a first agricultural product by the grower. The processor is also programmed to identify a second agricultural product appropriate for the first grower based at least in part on the historical sales data. The processor is further programmed to create a task for the salesperson. The task is related to engaging the first grower regarding the second agricultural product. The processor is also programmed to display the task to the salesperson for engaging the first grower.

In another aspect, a computer-implemented method for managing agricultural sales involving a salesperson and a first grower is provided. The method uses a computing device including a processor and a memory. The method includes storing, in the memory, historical sales data for the first grower in the database. The historical sales data includes a prior purchase of a first agricultural product by the grower. The method also includes identifying a second agricultural product appropriate for the first grower based at least in part on the historical sales data. The method further includes creating, by the processor, a task for the salesperson. The task is related to engaging the first grower regarding the second agricultural product. The method also includes displaying the task to the salesperson for engaging the first grower.

In yet another aspect, computer-readable non-transitory storage media having computer-executable instructions embodied thereon is provided. When executed by at least one processor, the computer-executable instructions cause the processor to store historical sales data for a first grower in the database. The historical sales data includes a prior purchase of a first agricultural product by the grower. The computer-executable instructions also cause the processor to identify a second agricultural product appropriate for the first grower based at least in part on the historical sales data. The computer-executable instructions further cause the processor to create a task for a salesperson. The task is related to engaging the first grower regarding the second agricultural product. The computer-executable instructions also cause the processor to display the task to the salesperson for engaging the first grower.

### BRIEF DESCRIPTION OF THE DRAWINGS

FIGS. 1-7 show example embodiments of the methods and systems described herein.

FIG. 1 is a schematic diagram of an example environment including a sales management system (SMS) and database configured to provide analytics and other functionality to multiple users involved in the supply chain that supports growers in the agricultural industry.

FIG. 2 is a simplified block diagram of an example system for supporting the multiple agricultural industry participants shown in FIG. 1.

FIG. 3 is an expanded block diagram of an example embodiment of a server architecture of a centralized database system including a plurality of computer devices in accordance with one example embodiment of the present disclosure.

FIG. 4 illustrates an example configuration of a server system that may be used to implement the system shown in FIG. 2.

FIG. 5 is a diagram of an example sales management system (SMS) used to manage multi-party sales relationships between a salesperson and one or more growers.

FIG. 6 is an example method for managing agricultural sales involving the salesperson the grower shown in FIG. 5 using the SMS shown in FIG. 5.

FIG. 7 shows an example configuration of a database within a computing device, along with other related computing components, that may be used to enhance use of data in agriculture management.

### DETAILED DESCRIPTION OF THE DISCLOSURE

Embodiments of the present disclosure facilitate leveraging agricultural data throughout the supply chain, from manufacturers to growers. Individual growers and/or sales people serving growers collect data about growers' fields. For example, field-level data is collected explaining what has been planted in a particular field or added to that field at a particular time. This field-level data may be generated by the grower during his normal course of operation, or it may be generated together with a salesperson, who may have witnessed a grower's particular situational facts, recommended a particular input, and/or conducted a sale with the grower. Additionally, field-level data may be collected from third parties, such as SST Software (“SST”) (Stillwater, Okla.). Such grower information is collected in a central database and leveraged by multiple parties in the supply chain.

The centralized database, and “unified data”, enables retailers to better provide actionable insights to individual growers in many ways. For example, centralization of grower data allows a salesperson to present detailed information to a grower about the grower's prior field inputs, and correlation of his prior inputs to his realized output. Further, such data is used to analyze projected yield variances given different input scenarios. A salesperson accesses the central database through, for example, a tablet computer while onsite with a grower. Real, actionable insights and value is delivered to the grower by leveraging the centralized data to help identify options and project comparative value for the grower.

System 10 provides an economic projections calculator for use by growers and/or salespersons (users of system 10) that allows the parties to analyze input scenarios and make economic projections based on those decisions. The calculator takes inputs such as a crop type, a yield projection (before the addition of any proposed inputs), a projected yield increase, environmental information, and estimated sale price data, such as from an existing grain contract, for the given crop type and projected quality. System 10 also receives a performance objective from the user. With these inputs, the calculator can provide relevant inputs, or inputs that are associated with the particular crop type, or particularly suitable environment, and display these to the user as input options. The calculator computes and displays the cost information for selected inputs and compares the projected costs against the projected revenues with and without the inputs. The calculator may provide a break-even point normalized to an acre basis. As such, the salesperson and/or the grower can see total projected net profits per acre, and make an informed decision using cost-benefit analysis of various input options.

Salespersons and/or growers leverage system 10 to build sales proposals during seasonal planning Plan data is input by a user of system 10 (i.e., salespersons and/or growers) indicating, for example, what type of seed is planned for a given field, and what other inputs may be desired. The salesperson may then generate a sales proposal for the grower. Such plan data is also utilized by the economic projections calculator, as discussed above.

System 10 also provides an integrated access to grower communications. As used herein, “communications” refers generally to any interactions between a grower and other supply chain entities, such as salespeople. For example, a salesperson uses system 10 to view all interactions with a certain grower, such as sales order history, data associated with text, phone, and email interactions, and site visits.

Further, salespersons also leverage the centralized data for prompting grower contact. For example, if a particular grower purchased a certain herbicide at a given time last season, the system recognizes that there may be a recurrence of the same problem again this season, and prompts the salesperson to initiate contact and a site visit to perhaps uncover the problem that might otherwise have gone undetected. This proactive notification by the salesperson may not only lead to an additional sale, but may also help build the salesperson's credibility as a trusted advisor by helping the grower avert a larger problem.

In some embodiments, the centralized data is also used to prompt grower contact to initiate sales in areas within and/or outside of what the grower normally buys from the salesperson. For example, fertilizer sales may be targeted. Growers' sales data is analyzed for growers that traditionally buy fertilizer from the salesperson, or for growers that purchase seed but not fertilizer. The salesperson may then be presented with a strong set of recommendations for the grower, given the known field-level data of that grower. The system prompts the salesperson to contact the grower with an incentive, at a seasonally-appropriate time, and with the set of recommendations. Such an approach may generate product sales in areas that otherwise may have gone elsewhere. Further, the grower also benefits by leveraging the analytical tools of the system and the centralized data as it relates to his own agronomic decision-making.

Manufacturers and suppliers leverage the centralized data as well. In some embodiments, a manufacturer or supplier may offer an objective for sales of a certain product, such as a percentage discount for buyers of that product, either broadly, or specifically for particular growers. The system then communicates the objective information to others in the supplier chain, such as salespersons and commercial retail entities, who may then choose whether or not to act on the objective relative to the individual growers that may have been identified. In other embodiments, a manufacturer can understand better what products to produce, and in what quantities, by studying the historical purchasing decisions of growers. Growers' purchasing decisions may also be analyzed relative to projected seasonal conditions.

In some embodiments, individual grower data may be directly available to other supply chain entities, such as manufacturers. In other embodiments, the individual grower data may be anonymized at some level. For example, individual grower data may be viewed by the growers themselves, and by the salespeople that directly serve them. But the data may be anonymized to other salespeople, or to the higher supply chain entities, such as the commercial retailers and/or the manufacturers and suppliers. Such anonymization may allow visibility of certain data to manufacturers, but only a distilled view. For example, a seed manufacturer may be able to see the total historical purchases for a given seed through the system, but only in a given county

In one embodiment, a computer program is provided, and the program is embodied on a computer readable medium. In an example embodiment, the system is executed on a computer system such as a salesperson's tablet computing device having a network connection to a database server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the invention by way of example and not by way of limitation. It is contemplated that the invention has general application to enhancing the use of agricultural data. The systems and processes are not limited to the specific embodiments described herein. In addition, components of each system and each process can be practiced independent and separate from other components and processes described herein. Each component and process also can be used in combination with other assembly packages and processes.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present invention are not intended to be interpreted as excluding the existence of additional embodiments that also incorporate the recited features.

As used herein, the term “database” may refer to either a body of data, or to a relational database management system (RDBMS), or both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL®, IBM® DB2, Microsoft® SQL Server, Sybase®, and PostgreSQL. However, any database may be used that enables the systems and methods described herein. (Oracle and MySQL are registered trademarks of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.) As used herein, the term “database system” refers specifically to a RDBMS.

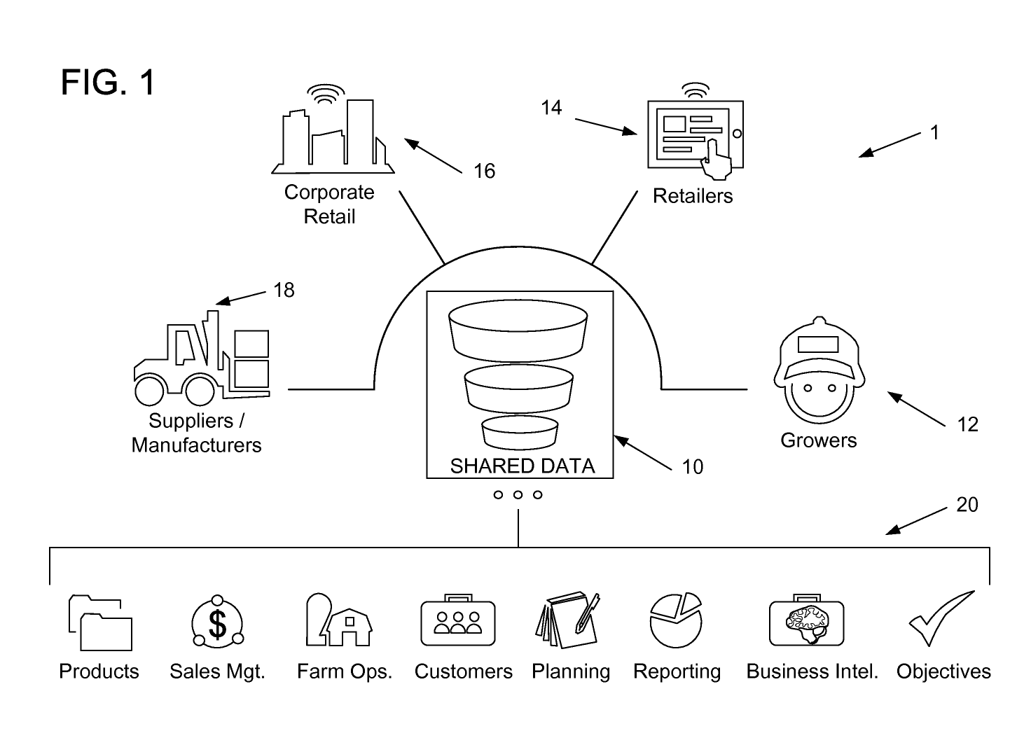

FIG. 1 is a schematic diagram of an example environment 1 including a sales management system (SMS) 10 and database configured to provide analytics and other functionality to multiple users involved in the supply chain that supports growers 12 in the agricultural industry. Growers 12, retailers 14, corporate retailers 16, and suppliers/manufacturers 18, collectively referred to as “participants”, “supply chain parties”, or “users” with respect to SMS 10, access SMS 10 through a network 11, such as the Internet. Each of the participants leverage SMS 10 for various tasks 20, such as sales management, collecting grower data, order tracking, planning and reporting, analysis of business intelligence, farming operations, communications tracking, task and actions management and tracking, objectives planning, and other business uses.

In the example embodiment, growers 12 generate data that is loaded into SMS 10 during their course of business. In some embodiments, SMS 10 includes data associated with growers 12 farming operations, such as field-level data about, for example, the geometries of a growers fields (i.e., the dimensional characteristics of the fields), what seed has been planted in a particular field at a given time and/or season, what fertilizer or other agricultural inputs have been applied, what environmental conditions the field has experienced, and productivity information after harvest. Growers 12 may also leverage data in SMS 10 for field management purposes. For example, an individual grower may access historical data stored in SMS 10 to analyze his agricultural inputs of a given field in past seasons, or may analyze the expenses of agricultural inputs as compared to production outputs.

As used herein, the term “field-level data” is used generally to refer to data about one or more fields of a grower. Some embodiments of the systems and methods described herein segregate growers' lands into individual, discrete fields, and track data associated with each field separately. Some data may be identified using locational coordinates and/or boundary lines, and may utilize Global Positioning Satellites (GPS) to acquire location information. As used herein, the term “agricultural input” refers to any product that is added to a grower's land and/or field. For example, seed, fertilizer, and pesticides are common agricultural inputs for growers to use. As used herein, the term “environmental conditions” refers to the environmental elements that a field is exposed to. For example, sun, rain, and pests may be classified as environmental elements that a field may be exposed to, and may be measured, tracked, recorded, and analyzed by the systems and methods described herein. In some uses, water may be considered an agricultural input and/or an environmental condition, and may be tracked separately when water is artificially added to a field, such as through the use of sprinklers. As used herein, the term “productivity information”, as it applies to growers and/or fields, refers to information associated with a harvest of the field. For example, productivity information may include information such as how much crop a field produced after a harvest, or the quality of the crop produced. Productivity information may refer to historical information, or may refer to projected values.

Retailers 14, in the example embodiment, represent salespersons of agricultural products, such as agricultural inputs. A salesperson, e.g., retailer 14, often maintains a close relationship with a set of customers, e.g., growers 12. The sales role at this level within the agricultural industry often involves the salesperson to know some detailed information about his customers. The salesperson may track information about an individual grower through the seasons, such as personal contact information, sales history, and field-level data, such as what environmental conditions the grower's field normally faces, what the grower has planted in given seasons, production information associated with fields, and the types of problems that the grower has faced.

The salesperson's role in the relationship may be purely as a conduit to purchase product, but growers often look to salesmen as “trusted advisors”, i.e., someone that can recommend courses of action. Individual growers have their own sets of experiences with their own fields, but salespeople have experiences and knowledge that extend beyond the individual grower's experiences. For example, because salesmen have relationships with many growers, they are exposed to other problems and solutions that may be leveraged for their other customers. Such insight makes a salesperson a valued advisor. Further, salespeople often have greater product knowledge than an individual grower. Growers may not always stay abreast of current product development, and the scenarios in which certain products may work best. Because salesmen are responsible for selling such products, they will have a greater base of knowledge to use, and can advise an individual grower about various product options and known facts using their own knowledge base in conjunction with SMS 10 data.

As a trusted advisor, a salesperson, in the example embodiment, leverages SMS 10 to maintain data known about his own growers 12. Moreover, the salesperson may also leverage data about other growers 12. Because data is consolidated in SMS 10 for many growers 12, a salesperson can look to experiences outside of his own customer base. For example, one individual grower may experience a particular problem or situational scenario for which neither the salesperson nor the individual grower has encountered. The salesperson uses SMS 10 to search for other growers that experienced a similar scenario, finds several other occurrences of the scenario, and analyzes the actions and results witnessed by the other growers. By leveraging a broad set of data in SMS 10, the salesperson is able to provide experiences beyond his own when advising his individual grower.

Further, in the example embodiment, retailers 14 leverage SMS 10 for sales task management. Grower 12 information is used to prompt salespersons to engage their customers in certain respects. For example, a particular grower may historically have purchased a certain agricultural input at a particular time in the season. To help ensure recurring sale, the salesperson is prompted with a task to approach the particular grower about another purchase of the product at a similar time during the following season. The grower benefits by a visit from the salesperson, a reminder of his historical purchases, and proactive prompting for a similar purchase. The salesperson benefits by anticipating the grower's needs and approaching the grower before the grower considers going off to another salesperson for a different product, thereby losing a sale.

Corporate retailers 16 and suppliers and manufacturers 18 also leverage SMS 10 for targeted execution of sales. As used herein, the terms “supplier” and “manufacturer” may be used interchangeably. In some embodiments, corporate retailers, suppliers, and manufacturers target aspects of their localized sales operations with SMS 10, such as by providing objectives to the retailers. For example, a corporate retailer may institute a loyalty discount for certain customers if they book their orders early in the season. This objective generates tasks that cascade down to various individual salespersons that manage the customers to which the objective relates. An individual task is created that is associated with a grower, and thus a particular salesperson. That salesperson uses SMS 10 to track and execute the task. In some embodiments, the salesperson carries a GPS-enabled mobile computing device with him in his travels. One way the task alerts the salesperson of the objective available for the grower is based on real-time proximity of the salesperson to the particular grower (i.e., using GPS location data and the grower's known location data).

Suppliers and Manufacturers 18, in the example embodiment, also leverage the shared data in SMS 10. For example, in some embodiments, suppliers and manufacturers 18 use historical purchasing data to plan for upcoming manufacturing and/or stocking levels for various products. SMS 10 shows what growers 12 purchased in past seasons, which can give insight into future production and stocking levels.

In other embodiments, corporate retailers 16 and/or suppliers and manufacturers 18 distribute product information, such as product specification sheets, on various products through SMS 10. This product information may be accessible and leveraged by growers 12 and/or retailers 14 during agriculture management.

In some embodiments, SMS 10 provides an overlay data display to one or more supply chain parties to assist in the sales process. For example, may be used to analyze whether grower 12 is meeting yield expectations. SMS 10 may receive data from third-party systems, such as the NASS (National Agricultural Statistics Service) cropland data layer, which provides average yield information for a particular crop in a given area. SMS 10 or one of the supply chain parties may leverage order data and/or yield results of grower 12 along with the NASS cropland data to determine that grower 12 is underachieving relative to regional averages. Based on this finding, SMS 10 or one of the supply chain parties may generate a task for the grower's salesperson, such as recommending/incentivizing a different seed or a different agronomic practice that may assist raising the yield. Other data may be leveraged similarly to drive sales and sales management practices and tasks. In some embodiments, SMS 10 overlays and/or displays to users multiple types of data such as back office accounting data, marketing program data from suppliers, scouting data, publicly-available NASS data, grower profile information, weather data, and manufacturer product technical specifications. Further, in some embodiments, SMS 10 may perform statistical analysis using such data to generate the tasks for salespeople.

In another embodiment, a salesperson may overlay field boundary data from third-party systems with order data of growers in a given region. Spatially, the salesperson or SMS 10 may analyze who has purchased certain things from you. For example, within a particular cluster of fields, the salesperson can see who has and has not already bought fertilizer. If the salesperson is already planning a visit to that area (e.g., to deliver fertilizer to other customers), SMS 10 or other supply chain parties may generate a task such as an incentive to offer fertilizer to the other growers in that area, thereby decreasing the cost to existing growers for delivery of that product. Such spatial view overlays help provide insights to salespeople relative to their growers 12.

In other embodiments, suppliers 18 may also use SMS 10 to overlay their own sales geography data with the retailer sales data to analyze their incentive programs are properly configured or miss-aligned. For example, a manufacturer 18 may have a sales geography called “Southern State X”. The retailer sales data may show that there are 300 customers within that geography that buy Product A from the manufacturer, and thus the manufacturer can provide an incentive based on the retailer's order data through an overlay.

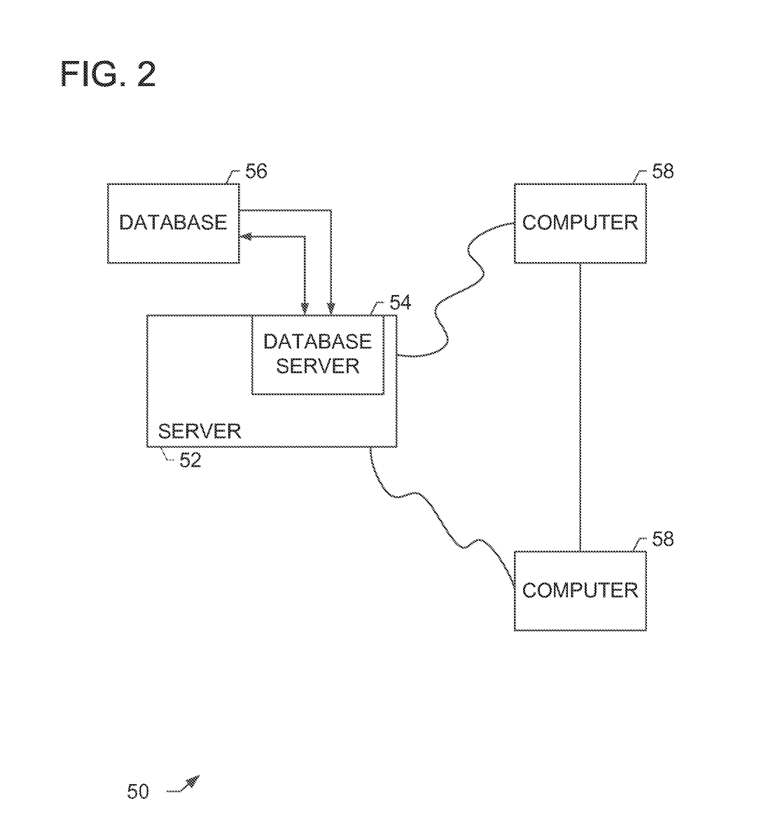

FIG. 2 is a simplified block diagram of an example system 50 for supporting the multiple agricultural industry participants shown in FIG. 1. In one embodiment, system 50 is similar to system 10 (shown in FIG. 1). More specifically, in the example embodiment, system 50 includes a server system 52, and a plurality of client sub-systems, also referred to as client systems 58, connected to server system 52. In one embodiment, client systems 58 are computer systems affiliated with the participants shown in FIG. 1, and include a web browser, and such that server system 52 is accessible to client systems 58 using the Internet. Client systems 58 are interconnected to the Internet through many interfaces including a network, such as a local area network (LAN) or a wide area network (WAN), dial-in-connections, cable modems, special high-speed ISDN lines, and cellular and/or mobile networks. Client systems 58 could be any device capable of interconnecting to the Internet including a web-based phone, personal digital assistant (PDA), tablet computer, or other web-based connectable equipment. A database server 54 is connected to a database 56 containing information on a variety of matters, as described within in greater detail. In one embodiment, centralized database 56 is stored on server system 52 and can be accessed by potential users at one of client systems 58 by logging onto server system 52 through one of client systems 58. In another embodiment, database 56 is stored remotely from server system 52.

As discussed within, grower information and other agricultural information is stored within database 56. For example, database 56 stores field-level data for growers, sales data associated with growers, manufacturing and product data for agricultural products, and other agricultural data that may be leveraged by the systems and methods as described herein.

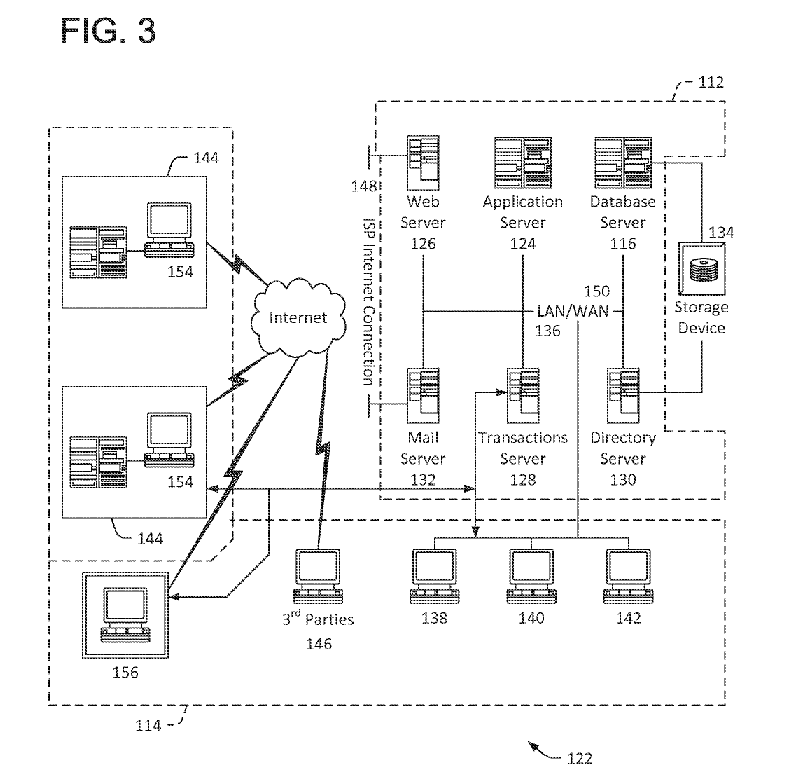

FIG. 3 is an expanded block diagram of an example embodiment of a server architecture for a centralized database system 122 including a plurality of computer devices in accordance with one example embodiment of the present disclosure. System 122 includes centralized database server 112 and client systems 114. Database server 112 further includes database management software 116, a transaction server 124, a web server 126, a transactions server 128, a directory server 130, and a mail server 132. A storage device 134 is coupled to database server 112. Database server 112 is coupled in a local area network (LAN) 136. In addition, some participants, such as suppliers and manufacturers 138, corporate retailers 140, and salespeople 142 may be coupled to LAN 136. Further, other participant computing devices 144 may access database server 112 through the Internet. Workstations 138, 140, and 142 are coupled to LAN 136 using an Internet link or are connected through an Intranet.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Database server 112 is configured to be communicatively coupled to various individuals, including participant computing devices 144, such as growers, suppliers, manufacturers, retailers, other data sources, etc., using an ISP Internet connection 148. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with user authentication server 112. Also, in the example embodiment, web server 126, application server 124, database server 116, and/or directory server 130 may host web applications, and may run on multiple server systems 112.

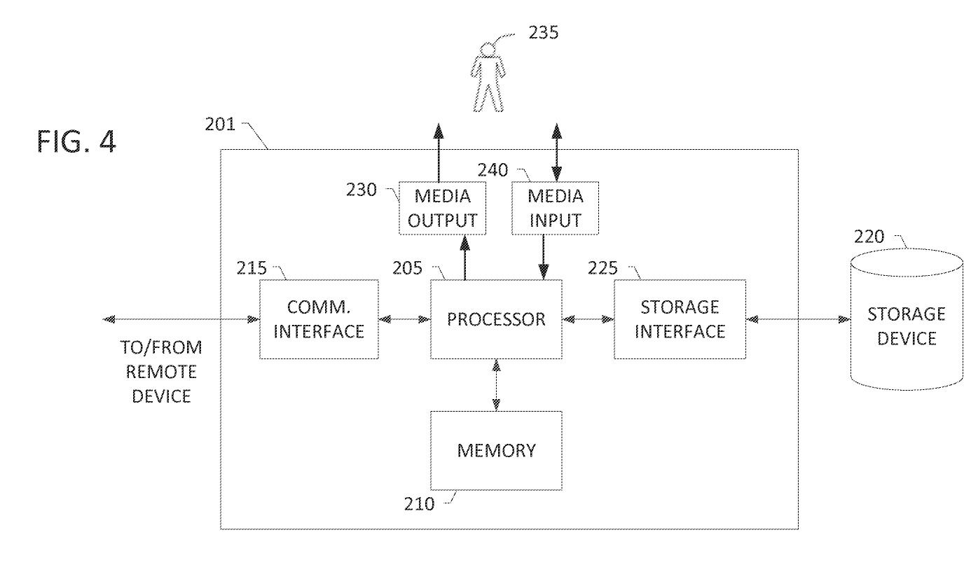

FIG. 4 illustrates an example configuration of a computing system 201 that may be used to implement agricultural database system 50 (shown in FIG. 2). Computing system 201 includes a processor 205 for executing instructions. Instructions may be stored in a memory area 210, for example. Processor 205 may include one or more processing units (e.g., in a multi-core configuration) for executing instructions. The instructions may be executed within a variety of different operating systems on the computing system 201, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc).

Processor 205 is operatively coupled to a communication interface 215 such that computing system 201 is capable of communicating with a remote device such as a user system or another computing system 201, or other computing devices (not shown in FIG. 4). Communication interface 215 may include, for example, a wired or wireless network adapter or a wireless data transceiver for use with a mobile phone network, Global System for Mobile communications (GSM), 3G, or other mobile data network or Worldwide Interoperability for Microwave Access (WIMAX). For example, communication interface 215 may communicatively couple with originator 110 (shown in FIG. 1) via the Internet, or any other network.

Processor 205 may also be operatively coupled to a storage device 220. Storage device 220 is any computer-operated hardware suitable for storing and/or retrieving data. In some embodiments, storage device 220 is integrated in computing system 201. For example, computing system 201 may include one or more hard disk drives as storage device 220. In other embodiments, storage device 220 is external to computing system 201 and may be accessed by a plurality of server systems 201. For example, storage device 220 may include multiple storage units such as hard disks or solid state disks in a redundant array of inexpensive disks (RAID) configuration. Storage device 220 may include a storage area network (SAN) and/or a network attached storage (NAS) system.

In some embodiments, processor 205 is operatively coupled to storage device 220 via a storage interface 225. Storage interface 225 is any component capable of providing processor 205 with access to storage device 220. Storage interface 225 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 205 with access to storage device 220.

Computing system 201 may also include at least one media output component 230 for presenting information to a user 235. Media output component 230 is any component capable of conveying information to user 235. In some embodiments, media output component 230 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, computing system 201 includes an input device 240 for receiving input from user 235. Input device 240 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 230 and input device 240.

Memory area 210 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

Stored in memory area 210 are, for example, computer readable instructions for providing a user interface to user 235 via media output component 230 and, optionally, receiving and processing input from input device 240. A user interface may include, among other possibilities, a web browser and client application. Web browsers enable users, such as user 235, to display and interact with media and other information typically embedded on a web page or a website from computing system 201. A client application allows user 235 to interact with a server application from computing system 201.

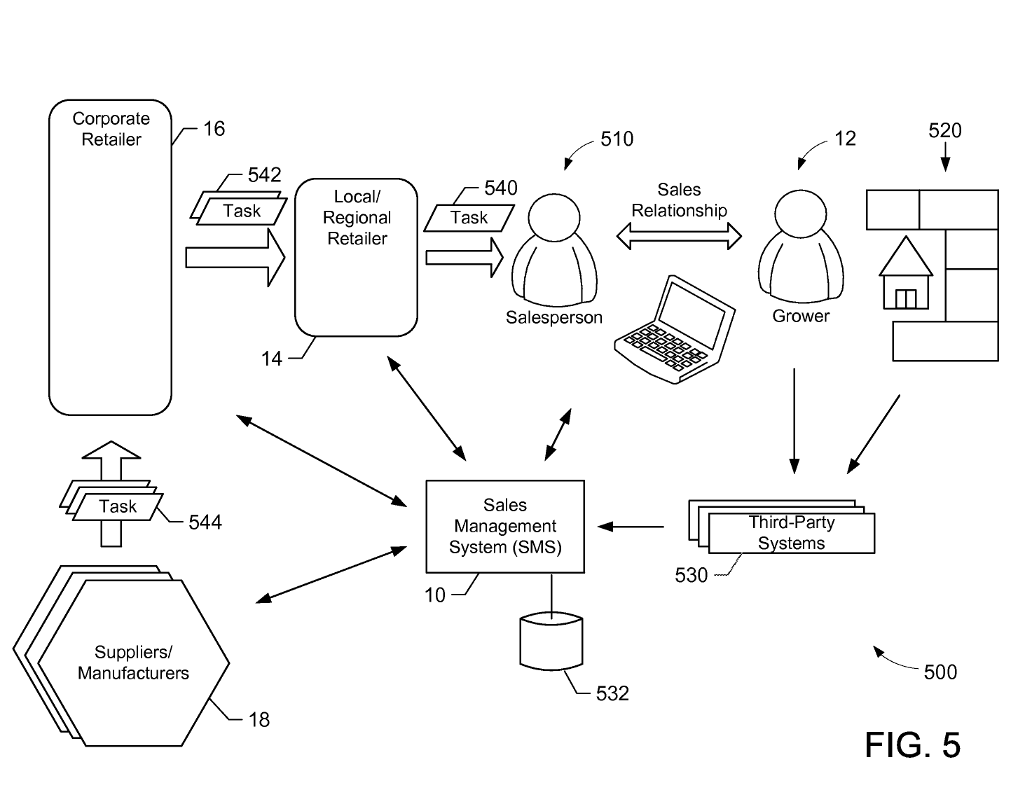

FIG. 5 is a diagram of an example sales management system (SMS) 10 used to manage multi-party sales relationships between a salesperson 510 and one or more growers 12. In some embodiments, SMS 10 is server 52 (shown in FIG. 2) or server system 112 (shown in FIG. 3), or computing device 201 (shown in FIG. 4). In the example embodiment, salesperson 510 maintains a working relationship with grower 12, and provides sales services and advice to grower 12 throughout their relationship. SMS 10 includes a database 502 that stores order history of growers 12 and other agricultural data associated with growers 12, salespersons 510, retailers 14 and 16, and suppliers 18. Grower 12 manages one or more fields 520 throughout one or more growing seasons. Salesperson 510 is directly managed by a local/regional retailer 14 and indirectly by a corporate retailer 16 and, more particularly, through SMS 10. Salesperson 510 offers for sale one or more products provided by one or more suppliers 18. Further, SMS 10 interacts with and receives data (e.g., precision agricultural data) from one or more third party systems 530.

In the example embodiment, the relationship between salesperson 510 and grower 12 is assisted and directed using SMS 10. More specifically, SMS 10 presents one or more “tasks” (e.g., tasks 540) to salesperson 510. Some tasks 540 are associated with specific growers 12. For example, task 540 may be a directive to salesperson 510 to conduct a site visit to grower 12, or to present a sales incentive for a particular product to grower 12, or to scout fields 520 of grower 12.

In some embodiments, tasks 540 may be generated by salesperson 510, or by retailers 14 and/or 16, or by suppliers 18, or by SMS 10. In the example embodiment, some suppliers 18 generate tasks such as sales incentives for a given product (e.g., a 10% discount for a particular type of seed or fertilizer). Suppliers 18 interact with SMS 10 to generate tasks 544. In some embodiments, some types of tasks 544 may be transmitted through SMS 10 directly to salesperson 510, or to a local/regional retailer 14. In the example embodiment, tasks 544 are transmitted through SMS 10 to corporate retailer 16. For example, after some sales analysis, supplier 18 may decide to direct a 10% discount on product X to several regions, or to a set of loyal customers (i.e., growers 12). Corporate retailer 16 receives tasks 544 through SMS 10, and may cascade (e.g., transmit) these tasks 542 down to one of their local/regional retailers 14, or may elect not to transmit some of these tasks 544. As such, some tasks 542 are transmitted through SMS 10 to local/regional retailers 14. Similarly, local/regional retailers 14 receive tasks 542 through SMS 10, and may cascade some of these tasks 540 down to their salespeople 510, but may elect not to transmit some of these tasks 542. Further, in the example embodiment, salespeople 510 may or may not act on the assigned tasks 540. In some embodiments, salesperson 510 may refuse or cancel task 540.

In other embodiments, corporate retailers 16 and/or local/regional retailers 14 generate tasks 542 and 540, respectively. These tasks cascade down to salespersons 510 as described above. In other words, corporate retailers 16 generate tasks 542 using SMS 10 and transmit those tasks 542 to some of their local/regional retailers 14, and the local/regional retailers 14 may or may not cascade those tasks 540 down to some or all of their salespeople 510. As such, SMS 10 offers a mechanism for various members of the sales chain (e.g., retailers 14 and 16, and suppliers/manufacturers 18) to influence product sales to growers 12.

In the example embodiment, SMS 10 maintains historical sales data for growers 12 in database 532. Sales data may include, for example, individual order data such as products purchased, date of purchase, field-level application data, and purchaser information. SMS 10 also maintains profile data on growers 12 such as, for example, grower name and address, field-level data (e.g., dimensions, location) for fields owned/managed by grower 12 (e.g., fields 520), and business entity information. Some such data may be provided by third-party systems 530.

In some embodiments, supply chain parties (e.g., salespersons 510, local/regional retailers 14, corporate retailers 16, and suppliers/manufacturers 18) or SMS 10 analyze past order data to generate tasks 540, 542, and 544. In one embodiment, a supply chain party may analyze past order data of grower 12 to generate a task 540 for engaging grower 12 for a repeat sale. For example, local retailer 14 may analyze grower's 12 prior season's seed purchases and generate task 540 for salesperson 510 to engage grower 12 for the same or similar purchase for the coming planting season. In some embodiments, this task 540 may be timed to alert salesperson 510 at a seasonally-appropriate time (e.g., in the early Fall, when many growers 12 often place reservations for the coming year's seed).

In another embodiment, a supply chain party may analyze past order data of grower 12 and/or other growers 12 to generate a task for engaging grower 12 for a complementary product recommendation. As used herein, the term “complementary products” is used generally to refer to a set of two or more products that tend to work well with, or somehow complement, each other. Complementary product data may be provided by suppliers/manufacturers 18 or other supply chain parties. In some situations, salespeople 510 may know and provide complementary product data. In the example embodiment, a supply chain party leverages past order data of growers 12 to determine or infer complementary products. For example, presume a particular grower 12 has purchased (or will likely purchase) a product X (e.g., a particular seed) from salesperson 510. SMS 10 analyzes past order data for other growers 12 that have also ordered product X, and SMS 10 determines which other products (e.g., product Y, a particular fertilizer) are commonly purchased by those same growers (e.g., based on a frequency of co-occurrence in historical orders). These other products may have been purchased by the other growers 12 because they are complementary. SMS 10 may also determine, down to a field level, which products were applied together (e.g., product X was planted on field “12345”, and later that year product Y was also applied to that same field “12345”). As such, a task (e.g., task 540) may be generated to approach grower 12 with a recommendation for the complementary product Y. Timing of such task 540 may also be determined based on the type of product, the product data, or the past sale data (e.g., what time of year is it most commonly sold).

In some embodiments, SMS 10 includes a scouting component that enables salespersons 510 or other parties to identify scouting data associated with grower 12 and the grower's fields 520. Scouting data may include agricultural event data such as, for example, a breakout of a weed or a pest at a particular location. Such scouting data may include GPS coordinates or other field-level data such as, for example, data that identifies the nature of the event, the location of the event, and any remediation efforts (e.g., field inputs) that were applied.

As such, in the example embodiment, SMS 10, salesperson 510, or any of the other supply chain parties may identify the agricultural event associated with one grower and generate one or more tasks based on that event. For example, in some embodiments, SMS 10 receives scouting data about a pest infestation within a particular field of another grower (not shown in FIG. 5). SMS 10 uses location information from the scouting data and/or field-level data of that other grower to locate nearby growers and fields, such as grower 12. In other words, grower 12 may be in danger of the same pest infestation based on fields 520 proximity to the other grower's fields (and the known pest infestation). Accordingly, SMS 10 or other supply chain parties may generate a scouting task for the associated salesperson. Upon receipt of this scouting task, salesperson may engage grower 12 for permission to scout fields 520 for similar infestations. Further, SMS 10 or other supply chain parties may determine an agricultural input appropriate for such an event (e.g., a particular pesticide), and may generate an order task for salesperson 510 to present to grower 12 in situations where fields 520 have also been affected by the event. For example, SMS 10 may determine the nature of the event from the scouting data (e.g., what weed, what pest, square acreage of the infestation, environmental conditions at the site) and may determine the appropriate product to apply based on such data. SMS 10 or other supply chain parties may examine similar past agricultural events and the remediation products applied (e.g., through historical order data or other scouting data). As such, salesperson 510 leverages SMS 10 to provide both alerts of nearby events that may cause greater problems for grower 12, and also recommendations for remediation based on historical events.

In some embodiments, SMS 10 provides trending data useful to suppliers 18 and/or retailers 14 and 16. For example, presume a particular supplier 18 has an active sales campaign associated with Product X. Using SMS 10, supplier 18 may evaluate the ongoing impact of various incentives for Product X that it has tasked out to retailers 14 and 16, and salespeople 510. SMS 10 can, for example, display the actions taken or not taken on the various tasks 544 that it has released to the downstream supply chain parties. If, for example, many salespeople 510 are not accepting or acting on that supplier's 18 tasks 544, supplier 18 may investigate the nature of the ineffectiveness and may alter course during the program (e.g., increase/decrease incentives, roll out promotional materials, increase advertisement, etc.).

In the example embodiment, SMS 10 anonymizes grower data such as to prevent one or more up-stream supply chain parties from full access to the identity of grower 12. For example, salesperson 510 may collect, and SMS 10 may maintain, full profile data for grower 12 (e.g., grower's name, address, business entity name, field locations), but SMS 10 may mask this level of detail from, for example, individual suppliers 18, by, for example, creating a grower ID (identifier) for each individual grower. When the up-stream supply chain parties access grower data, some grower data may be anonymized such that individual growers may not be identified. In some embodiments, some up-stream parties may only see data in aggregate (e.g., summed together).

Further, in some situations, grower 12 may place an order for an agricultural product (e.g., a seed reservation) under their own name (e.g., their personal name), but due to licensing requirements, the agricultural product may require licensing to a business entity associated with grower 12. As such, SMS 10 can track and anonymize order data in the growers name and subsequently associate the delivery and licensing of the order to the business entity. Salesperson 510 inputs into SMS 10 the grower profile data which includes both the grower's name and the grower's associated business entity. SMS 10 may then anonymize and correlate between the two identifiers for grower 12.

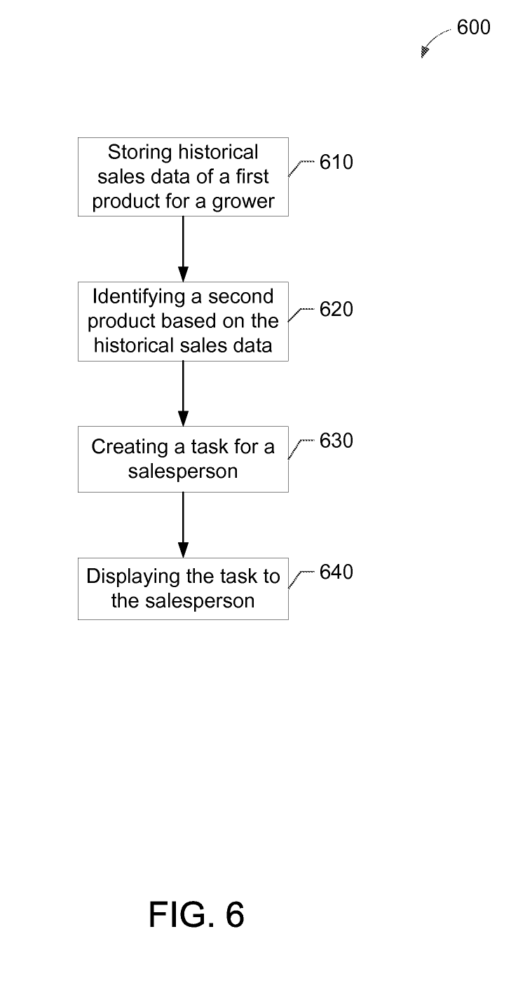

FIG. 6 is an example method 600 for managing agricultural sales involving a salesperson 510 (shown in FIG. 5) and a first grower 12 (shown in FIG. 5). In the example embodiment, method 600 uses a computing device including a processor and a memory. In some embodiments, method 600 uses server 52 (shown in FIG. 2) or server system 112 (shown in FIG. 3) or computing device 201 (shown in FIG. 4). In the example embodiment, method 600 includes storing 610, in the memory, historical sales data for the first grower in the database, the historical sales data including a prior purchase of a first agricultural product by the grower.

In the example embodiment, method 600 also includes identifying 620 a second agricultural product appropriate for the first grower based at least in part on the historical sales data. In some embodiments, identifying 620 includes identifying a plurality of historical sales orders including the first agricultural product, and determining the second agricultural product from the identified historical sales orders based at least in part on a frequency of occurrence of the second product with the first agricultural product within the identified historical sales orders. In other embodiments, identifying 620 a second agricultural product appropriate for the first grower is further based at least in part on one or more of (i) the scouting data and (ii) the agricultural event.

Method 600, in the example embodiment, also includes creating 630, by the processor, a task for the salesperson, wherein the task is related to engaging the first grower regarding the second agricultural product. In some embodiments, method 600 includes generating the task by one of (i) a supplier of the second agricultural product and (ii) a retailer of the second agricultural product. Method 600 also includes displaying 640 the task to the salesperson for engaging the first grower.

In some embodiments, method 600 includes identifying scouting data of a second grower, the scouting data including an agricultural event associated with the second grower, and selecting the first grower based at least in part on proximity to the second grower. In other embodiments, method 600 includes storing historical sales data for a plurality of growers in the database, the historical sales data including data associated with the first agricultural product, and providing trend data associated with the first agricultural product to one or more of a supplier of the first agricultural product, a retailer of the first agricultural product, and the salesperson. In still other embodiments, method 600 includes storing a grower name of the first grower and a business name associated with the first grower, generating an order request for the first grower, the order request identifying the first grower by the grower name, identifying a delivery component associated with the order request, the delivery component identifying the first grower by the business name, and associating the delivery component with the order request based at least in part on identifying the first grower using the grower name from the order request and the business name from the delivery component.

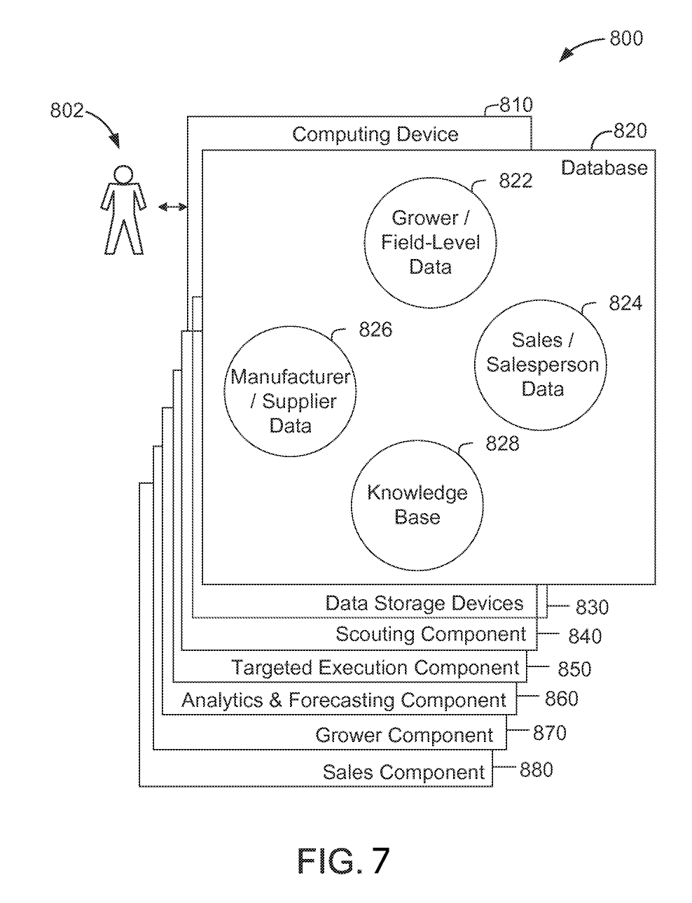

FIG. 7 shows an example configuration of a database 820 within a computing device 810, along with other related computing components, that may be used to enhance use of data in agriculture management. In some embodiments, computing device 810 and database 820 is similar to SMS 10 (shown in FIGS. 1 and 5), server 52 (shown in FIG. 2), server system 112 (shown in FIG. 3), and/or computing device 201 (shown in FIG. 4). Database 820 is coupled to several separate components within computing device 810, which perform specific tasks. In some embodiments, database 820 is similar to database 532 (shown in FIG. 5).

In the example embodiment, database 820 includes grower and field-level data 822, sales and salesperson data 824, manufacturer and supplier data 826, and knowledge base data 828. Grower and field-level data 822 includes grower information such as, for example, field-level data associated with particular growers. In some embodiments, grower and field-level data 822 may include data from third-party data providers. Sales and salesperson data 824 includes information associated with sales functions such as, for example, tasks tracked for salespeople, or sales transactions conducted with growers. Manufacturer and supplier data 826 includes information associated with manufacturers and suppliers of agricultural products. Knowledge base data 828 includes a variety of data such as, for example, known agricultural knowledge on seeds, insects, farming, weather, and agricultural inputs and products.

Computing device 810 includes the database 820, as well as data storage devices 830. Computing device 810 also includes a scouting component 840 for collecting grower and field-level data 822, a targeted execution component 850 for creation of sales objectives through analysis of grower data, and an analytics and forecasting component 860 for calculating costs and benefits associated with grower input scenarios. A grower component 870 and a sales component 880 assist growers and sellers in their various tasks, as described above.

In one embodiment, a computer program is provided, and the program is embodied on a computer readable medium and utilizes a Structured Query Language (SQL) with a client user interface front-end for administration and a web interface for standard user input and reports. In an example embodiment, the system is web enabled and is run on a business-entity intranet. In yet another embodiment, the system is fully accessed by individuals having an authorized access outside the firewall of the business-entity through the Internet. In a further example embodiment, the system is being run in a Windows® environment (Windows is a registered trademark of Microsoft Corporation, Redmond, Wash.). The application is flexible and designed to run in various different environments without compromising any major functionality.

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof, wherein the technical effect is a system leveraging agricultural data associated with growers, salespersons, retailers, suppliers and manufacturers associated with the agricultural industry. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of methods and systems of enhancing use of data in agriculture management provide a centralized system for collecting and analyzing data to provide analytics to growers, retailers, suppliers, and manufacturers. As a result, the methods and systems described herein facilitate data-driven analytical decision making in aspects of agriculture management.

As will be appreciated based on the foregoing specification, the above-described embodiments of the disclosure may be implemented using computer programming or engineering techniques including computer software, firmware, hardware or any combination or subset thereof, wherein the technical effect is identifying a first plurality of agricultural information from one or more of a grower and a retailer, transmitting the first plurality of agricultural information to said database module for storing in the database receiving, from the database module, the first plurality of agricultural information, determining an agricultural input product option based at least in part on the first plurality of agricultural information, and providing economic information associated with the agricultural input product option to the grower. Any such resulting program, having computer-readable code means, may be embodied or provided within one or more computer-readable media, thereby making a computer program product (i.e., an article of manufacture) according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer system for managing agricultural sales involving a salesperson and a first grower, said computer system comprising:
a database; and
a processor programmed to:
store historical sales data for the first grower in the database, the historical sales data including a prior purchase of a first agricultural product by the grower;
identify a second agricultural product appropriate for the first grower based at least in part on the historical sales data;
create a task for the salesperson, wherein the task is related to engaging the first grower regarding the second agricultural product; and
display the task to the salesperson for engaging the first grower.

2. The computer system of claim 1, wherein the task is generated by one of a supplier of the second agricultural product and a retailer of the second agricultural product.

3. The computer system of claim 1, wherein identifying a second agricultural product includes:
identifying a plurality of historical sales orders including the first agricultural product; and
determining the second agricultural product from the identified historical sales orders based at least in part on a frequency of occurrence of the second product with the first agricultural product within the identified historical sales orders.

4. The computer system of claim 1, wherein the processor is further programmed to:
identify scouting data of a second grower, the scouting data including an agricultural event associated with the second grower; and
select the first grower based at least in part on proximity to the second grower.

5. The computer system of claim 4, wherein identifying a second agricultural product appropriate for the first grower is further based at least in part on one or more of (i) the scouting data and (ii) the agricultural event.

6. The computer system of claim 1, wherein the processor is further programmed to:
store historical sales data for a plurality of growers in the database, the historical sales data including data associated with the first agricultural product; and
provide trend data associated with the first agricultural product to one or more of a supplier of the first agricultural product, a retailer of the first agricultural product, and the salesperson.

7. The computer system of claim 1, wherein the processor is further programmed to:
store a grower name of the first grower and a business name associated with the first grower;
generate an order request for the first grower, the order request identifying the first grower by the grower name;
identify a delivery component associated with the order request, the delivery component identifying the first grower by the business name; and
associate the delivery component with the order request based at least in part on identifying the first grower using the grower name from the order request and the business name from the delivery component.

8. A computer-implemented method for managing agricultural sales involving a salesperson and a first grower, said method using a computing device including a processor and a memory, said method comprising:
storing, in the memory, historical sales data for the first grower in the database, the historical sales data including a prior purchase of a first agricultural product by the grower;
identifying a second agricultural product appropriate for the first grower based at least in part on the historical sales data;
creating, by the processor, a task for the salesperson, wherein the task is related to engaging the first grower regarding the second agricultural product; and
displaying the task to the salesperson for engaging the first grower.

9. The method of claim 8 further comprising generating the task by one of (i) a supplier of the second agricultural product and (ii) a retailer of the second agricultural product.

10. The method of claim 8, wherein identifying a second agricultural product includes:
identifying a plurality of historical sales orders including the first agricultural product; and
determining the second agricultural product from the identified historical sales orders based at least in part on a frequency of occurrence of the second product with the first agricultural product within the identified historical sales orders.

11. The method of claim 8 further comprising:
identifying scouting data of a second grower, the scouting data including an agricultural event associated with the second grower; and
selecting the first grower based at least in part on proximity to the second grower.

12. The method of claim 11, wherein identifying a second agricultural product appropriate for the first grower is further based at least in part on one or more of (i) the scouting data and (ii) the agricultural event.

13. The method of claim 8 further comprising:
storing historical sales data for a plurality of growers in the database, the historical sales data including data associated with the first agricultural product; and
providing trend data associated with the first agricultural product to one or more of a supplier of the first agricultural product, a retailer of the first agricultural product, and the salesperson.

14. The method of claim 8 further comprising:
storing a grower name of the first grower and a business name associated with the first grower;
generating an order request for the first grower, the order request identifying the first grower by the grower name;
identifying a delivery component associated with the order request, the delivery component identifying the first grower by the business name; and
associating the delivery component with the order request based at least in part on identifying the first grower using the grower name from the order request and the business name from the delivery component.

15. Computer-readable non-transitory storage media having computer-executable instructions embodied thereon, wherein, when executed by at least one processor, the computer-executable instructions cause the processor to:
store historical sales data for a first grower in the database, the historical sales data including a prior purchase of a first agricultural product by the grower;
identify a second agricultural product appropriate for the first grower based at least in part on the historical sales data;
create a task for a salesperson, wherein the task is related to engaging the first grower regarding the second agricultural product; and
display the task to the salesperson for engaging the first grower.

16. The computer program product of claim 15, wherein the task is generated by one of a supplier of the second agricultural product and a retailer of the second agricultural product.

17. The computer program product of claim 15, wherein identifying a second agricultural product includes:
identifying a plurality of historical sales orders including the first agricultural product; and
determining the second agricultural product from the identified historical sales orders based at least in part on a frequency of occurrence of the second product with the first agricultural product within the identified historical sales orders.

18. The computer program product of claim 15, wherein the computer-executable instructions also cause the processor to:
identify scouting data of a second grower, the scouting data including an agricultural event associated with the second grower; and
select the first grower based at least in part on proximity to the second grower.

19. The computer program product of claim 18, wherein identifying a second agricultural product appropriate for the first grower is further based at least in part on one or more of (i) the scouting data and (ii) the agricultural event.

20. The computer program product of claim 15, wherein the computer-executable instructions also cause the processor to:
store historical sales data for a plurality of growers in the database, the historical sales data including data associated with the first agricultural product; and
provide trend data associated with the first agricultural product to one or more of a supplier of the first agricultural product, a retailer of the first agricultural product, and the salesperson.

21. The computer program product of claim 15, wherein the computer-executable instructions also cause the processor to:
store a grower name of the first grower and a business name associated with the first grower;
generate an order request for the first grower, the order request identifying the first grower by the grower name;
identify a delivery component associated with the order request, the delivery component identifying the first grower by the business name; and
associate the delivery component with the order request based at least in part on identifying the first grower using the grower name from the order request and the business name from the delivery component.
